(19) United States
(12) Patent Application Publication
(10) Pub. No.: US 2012/0099761 A1
(43) Pub. Date: Apr. 26, 2012

(54) COOKER AND CONTROL METHOD THEREOF

(76) Inventors: Yoo-Sool Yoon, Seoul (KR); Jeong-Hyun Lim, Seoul (KR); Koon-Seok Lee, Seoul (KR)

(21) Appl. No.: 13/376,739

(22) PCT Filed: Jun. 15, 2010
(86) PCT No.: PCT/KR10/03843

§ 371 Date: Dec. 7, 2011

(30) Foreign Application Priority Data
Jun. 15, 2009 (KR) 10-2009-0053049

(51) Int. Cl. G06K 9/00

(52) U.S. Cl. 382/100

(57) ABSTRACT

Provided are a cooker and a method for controlling the same. A cooked degree of food may be determined through a variation of a food size read from a food image scanned by an image sensor in a cooking chamber. Thus, the cooked degree of the food in the cooking chamber may be more accurately determined.

### TECHNICAL FIELD

The present disclosure relates to a cooker, and more particularly, to a cooker for scanning food to display a food image and a method for controlling the cooker.

### BACKGROUND ART

Cookers are home appliances for cooking food with electricity or gaseous fuel. Such a cooker includes a heat source for heating food in a cooking chamber. The cooker also includes a temperature sensor or a humidity sensor for sensing temperature or humidity of the cooking chamber. An operation of the heat source is controlled according to a temperature or humidity sensed by the temperature sensor or the humidity sensor, thereby facilitating the cooking of the food in the cooking chamber.

### DISCLOSURE

### Technical Problem

Embodiments provide a cooker that more accurately detects an inner state of a cooking chamber and a method for controlling the cooker.

### Technical Solution

In one embodiment, a cooker includes: a main body including a cooking chamber in which food is cooked; a heat source providing heat for heating the food in the cooking chamber; an image sensor horizontally scanning the food in the cooking chamber; and a control part determining a cooked state of the food from a variation of a horizontal image size of the food scanned by the image sensor through an operation of the heat source.

In another embodiment, a cooker includes: a main body including a cooking chamber in which food is cooked; a heat source providing heat for heating the food in the cooking chamber; a first image sensor for scanning the food in the cooking chamber in a first direction; a second image sensor for scanning the food in the cooking chamber in a second direction; and a control part determining a cooked state of the food from a variation of a food volume calculated from the first and second images of the food scanned by the first and second image sensors through an operation of the heat source.

In further another embodiment, a method for controlling a cooker includes: scanning food in a cooking chamber in a horizontal direction through an image sensor; starting an operation of a heat source to cook the food in the cooking chamber; and determining a cooked state of the food according to a variation of a horizontal image size of the food scanned by the image sensor through a control part.

In still further another embodiment, a method for controlling a cooker includes: scanning food in a cooking chamber through first and second image sensors in vertical and horizontal directions; starting an operation of a heat source to cook the food in the cooking chamber; and determining a cooked state of the food according to a variation of a food volume calculated from vertical and horizontal images of the food scanned by the first and second image sensors through a control part.

The details of one or more embodiments are set forth in the accompanying drawings and the description below. Other features will be apparent from the description and drawings, and from the claims.

### ADVANTAGEOUS EFFECTS

According to the embodiments, the cooked degree of the food in the cooking chamber may be more accurately determined.

### DESCRIPTION OF DRAWINGS

FIG. 1 is a perspective view of a cooker according to a first embodiment.

FIG. 2 is a schematic view of the cooker according to the first embodiment.

FIG. 3 is a schematic view of a cooker according to a second embodiment.

FIG. 4 is a flowchart illustrating a process for controlling the cooker according to the first embodiment.

FIG. 5 is a flowchart illustrating a process for controlling a cooker according to a second embodiment.

### MODE FOR INVENTION

Hereinafter, a cooker according to a first embodiment will be described in detail with reference to accompanying drawings.

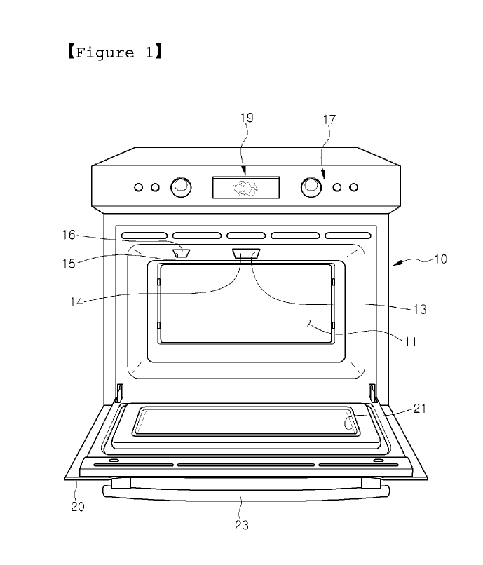

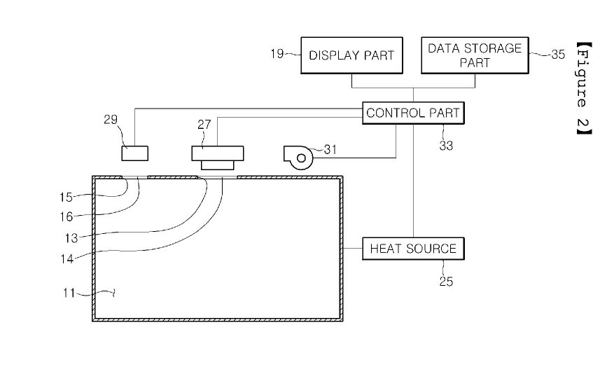

FIG. 1 is a perspective view of a cooker according to a first embodiment. FIG. 2 is a schematic view of the cooker according to a the first embodiment.

Referring to FIGS. 1 and 2, a cooker according to the current embodiment includes a main body 10 that accommodates a cooking chamber 11. The cooking chamber 11 provides a space for cooking food.

A sensing opening 13 is defined at a side of a top surface of the cooking chamber 11. A shield glass 14 is disposed in the sensing opening 13. The position of the sensing opening 13 is not limited to the top surface of the cooking chamber 11. For example, the sensing opening 13 may be defined in one of both side surfaces of the cooking chamber 11 or a rear surface of the cooking chamber 11. A lighting opening 15 is defined at a side of the top surface of the cooking chamber 11.

A lighting opening 15 is defined at a side of the top surface of the cooking chamber 11. Also, a shield glass 16 is disposed in the sensing opening 15. Although the lighting opening 15 is disposed at a side of the top surface of the cooking chamber 11 adjacent to the sensing opening 13, the present disclosure is not limited thereto.

An input part 17 and a display part 19 are disposed on a front upper portion of the main body 10 corresponding to an upper side of the cooking chamber 11. The input part 17 receives a manipulation signal for operating the cooker. The display part 19 displays an inner state of the cooking chamber 11 detected by an image sensor 27 to be described later. Although the input part 17 and the display part 19 are disposed on the front upper portion of the main body 10, the present disclosure is not limited thereto. For example, the input part 17 and the display part 19 may be disposed on the front left and right portions of the main body 10.

The cooking chamber 11 is selectively opened and closed by a door 20. The front end of the door 20 rotates about a vertical axis thereof in front and rear directions of the main body 10. A viewing window 21 is disposed in the door 20. A user may directly see the inner state of the cooking chamber 11 through the viewing window 21. For example, a central portion of the door 20 may be formed of a transparent or translucent material to provide the viewing window 21. Also, a door handle 23 to be grasped by the user is disposed on a front upper end of the door 20 to open and close the door 20.

A heat source 25 is disposed in the main body 10. The heat source 25 heats food in the cooking chamber 11. For example, the heat source 25 may include at least one of a high frequency heat source emitting microwaves into the cooking chamber 11 and a radiant heat source and convection heat source respectively supplying radiant heat and convection heat into the cooking chamber 11.

The image sensor 27 is disposed in the main body 10. The image sensor 27 scans the inner portion of the cooking chamber 11, i.e., food received in the cooking chamber 11. For this, the image sensor 27 has a predetermined angle of view. In the current embodiment, the image sensor 27 is disposed at an upper side of the main body 10, i.e., an upper side of the cooking chamber 11 corresponding to an upper side of the sensing opening 13 provided with the shield glass 14.

A lamp 29 is disposed in the main body 10. The lamp illuminates the inside of the cooking chamber 11. The lamp 29 is disposed above the lighting opening 15.

A cooling fan 31 disposed in the main body 10 is adjacent to the image sensor 27. The cooling fan 31 generates an air flow for cooling the image sensor 27. Although the cooling fan 31 is separately provided to cool the image sensor 27 in the current embodiment, the image sensor 27 may be cooled by a cooling fan (not shown) for cooling the heat source 25.

A control part 33 controls operations of the heat source 25, the image sensor 27, and the display part 19. In detail, the control part 33 controls an operation of the heat source 25 according to a manipulation signal inputted into the input part 17. The control part 33 controls the image sensor 27 to scan food and controls the display part 19 to display an image of the scanned food. Here, the control part 33 controls the image sensor 27 to scan the food in real time before the heat source is operated and controls the image sensor 27 to stop the operation of the image sensor 27 after the heat source 25 is stopped. The control part 33 also controls the display part 19 to operate the display part 19 when the image sensor 27 is operated. Thus, the operations of the display part 19 and the image sensor 27 may simultaneously start and simultaneously stop. Also, the control part 33 determines a cooked degree of the food and whether the cooking is finished through the food image scanned by the image sensor 27 to control an operation of the heat source 25.

In the current embodiment, the control part 33 determines a cooked degree of the food according to a variation of a horizontal size of the food image scanned by the image sensor 27.

In detail, the control part 33 compares the variation of the horizontal size of the food image to a preset reference variation depending on an elapsed time to determine the cooked degree of the food. For example, the control part 33 determines that the cooking of the food is finished when the variation of the horizontal size of the food image reaches the reference variation. When the control part 33 determines that the cooking of the food is finished according to the variation of the horizontal size of the food image, the control part 33 controls the heat source 25 to stop the operation of the heat source 25. Here, the determination of the cooked degree according to the variation of the horizontal size of the food image may be applied to a food such as bread that change in volume in the cooking process. Also, the reference variation may be set to different values according to the food.

The control part 33 controls operations of the lamp 29 and the cooling fan 31. In the current embodiment, the control part 33 controls the lamp 29 and the cooling fan 31 to operate the lamp 29 and the cooling fan 31 before the image sensor 27 is operated or when the image sensor 27 is operated. Also, the control part 33 controls the lamp 29 and the cooling fan 31 to finish the operations of the lamp 29 and the cooling fan 31 when the operation of the image sensor 27 is stopped or after the operation of the image sensor 27 is finished.

The reference variation is stored in a data storage part 35. Here, the data storage part 35 stores the reference variation according to a kind of food.

Hereinafter, an operation of the cooker according to the first embodiment will be described in detail with reference to accompanying drawings.

First, a process in which the food is scanned to display the scanned food image in the cooker according to the first embodiment will be described.

The user rotates the door 20 to shield the cooking chamber in a state where the food is received into the cooking chamber 11. Then, when the user manipulates the input part 17 to input a manipulation signal for cooking the food, the control part 33 controls the heat source 25 to operate the heat source 25. Thus, the food is cooked in the cooking chamber 11.

The control part 33 controls the image sensor 27 and the lamp 29 to operate the image sensor 27 and the lamp before an operation of the heat source 25 starts. Thus, the image sensor scans the inner portion of the cooking chamber 11 in real time. An image of the food scanned by the image sensor 27 is displayed through the display part 19. The control part 33 controls the cooling fan to operate the cooling fan, thereby cooling the image sensor 27.

Here, the control part 33 reads the variation of the food image scanned by the image sensor 27 to compare a variation depending on an elapsed time to the reference RGB color value variation, thereby determining whether the variation of the horizontal size of the food image reaches the reference variation. When the control part 33 determines that the variation of the horizontal size of the food image reaches the reference variation, the control part 33 controls the heat source 25 to stop the operation of the heat source 25. When the operation of the heat source 25 is stopped, the control part 33 controls the image sensor 27, the lamp 29, and the cooling fan 31 to stop the operations of the image sensor 27, the lamp 29, and the cooling fan 31.

The control part 33 controls the display part 19 to display the food image scanned by the image sensor 27 through the display part 19. Thus, the user may easily determine the cooked degree of the food and whether the cooking is finished in the cooking chamber 11 from the food image displayed on the display part 19.

Hereinafter, a cooker according to a second embodiment will be described in detail with reference to accompanying drawings.

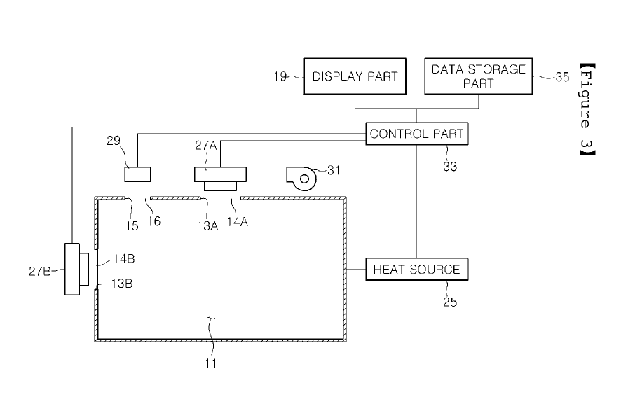

FIG. 3 is a schematic view of a cooker according to a second embodiment. Here, the same components as those of the foregoing first embodiment will be denoted by the same reference numerals as those of FIGS. 1 and 2 and their detained descriptions will be omitted.

Referring to FIG. 3, a cooker according to the current embodiment includes first and second image sensor 27A and 27B for scanning food in a cooking chamber 11. Each of the first and second image sensors 27A and 27B scans the food in the cooking chamber 11 in a first or second direction.

In detail, first and second sensing openings 13A and 13B are defined in a ceiling and a side surface of the cooking chamber 11, respectively. Also, first and second shield glasses 14A and 14B are disposed in the first and second sensing opening 13A and 13B, respectively.

The first and second image sensors 27A and 27B scan the food in the cooking chamber 11 through the first and second sensing openings 13A and 13B, respectively. Hereinafter, for convenience of description, an image of the food scanned by the first image sensor 27A in the first direction, i.e., a vertical direction is called a first image, and an image of the food scanned by the second image sensor 27B in the second direction, i.e., a horizontal direction is called a second image.

The control part 33 calculates a volume variation of the food from the first and second images of the food scanned by the first and second image sensors 27A and 27B. The control part 33 compares the volume variation of the food calculated from the first and second images of the food to a preset reference variation depending on an elapsed time. Then, when the volume variation of the food reaches the reference variation, the control part 33 determines that the cooking of the food is finished. When the control part 33 determines that the cooking of the food is finished, the control part 33 controls operations of a heat source 25, a lamp 29, and a cooling fan 31.

In the current embodiment, the volume of the food may be calculated from the images of the food scanned in two direction perpendicular to each other. Thus, the first and second image sensors 27A and 27B may be installed on two different surfaces perpendicular to each other among a ceiling, a bottom, both side surfaces, and a back surface of the cooking chamber 11. Also, three image sensors may be used to more accurately calculate the volume of the food.

Hereinafter, a method for controlling the cooker according to the first embodiment will be described in detail with reference to accompanying drawings.

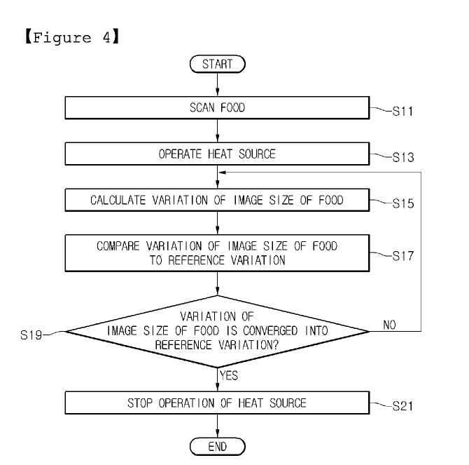

FIG. 4 is a flowchart illustrating a process for controlling the cooker according to the first embodiment.

Referring to FIG. 4, an image sensor 27 scans the inside of a cooking chamber 11 in operation S11. In the operation S11, the image sensor 27 may scan the inside of the cooking chamber 11 including food seated inside the cooking chamber 11.

In operation S13, a heat source 25 is operated to heat the food in the cooking chamber 11. Since the food in the cooking chamber 11 is heated by the operation of the heat source 25 in the operation S13, a volume of the food may be changed. Specifically, a food such as bread may be significantly changed in volume.

In operation S15, a control part 33 calculates a variation of a size of the food image scanned by the image sensor 27. That is, a variation of the volume of the food heated by the heat source 25 is calculated from the image size of the food.

In operation S17, the control part 33 compares the variation of the image size of the food calculated in the operation S15 to a preset reference variation. Here, the reference variation may be differentially set according to a kind of food. In operation S19, the control part 33 determines whether the variation of the image size of the food reaches the reference variation.

When the variation of the image size of the food reaches the reference variation in the operation S19, the control part 33 determines that the cooking of the food in the cooking chamber 11 is finished. In operation S1, the control part 33 controls the heat source 25 to stop the operation of the heat source 25.

If the variation of the image size of the food does not reach the reference variation in the operation S19, the control part 33 determines that the cooking of the food in the cooking chamber 11 is not finished yet. Thus, the control part 33 performs the operations S15 to S19.

Hereinafter, a method for controlling the cooker according to the second embodiment will be described in detail with reference to accompanying drawings.

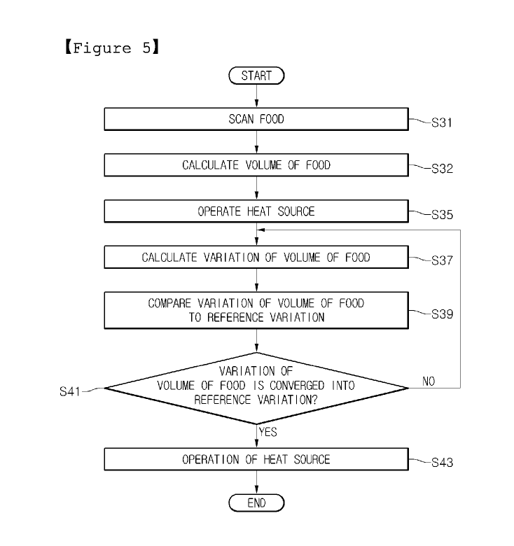

FIG. 5 is a flowchart illustrating a process for controlling the cooker according to the second embodiment.

Referring to FIG. 5, first and second image sensors 27A and 27B scan the inside of a cooking chamber 11 in operation S31.

Here, the first image sensor 27A vertically scans the inside of the cooking chamber 11, and the second image sensor 27B horizontally scans the inside of the cooking chamber 11.

In operation S33, the control part 33 calculates a volume of the food from the food image scanned by the first and second image sensors 27A and 27B in the operation S31. That is, the control part 33 calculates a volume of the food from a first vertical image of the food and a second horizontal image of the food.

In operation S35, a heat source 25 is operated to heat the food in the cooking chamber 11. The volume of the food may increase by the operation of the heat source 25.

In operation S37, the control part 33 calculates a vibration of the food volume from vibrations of first and second image sizes of the food scanned by the first and second image sensors 27A and 27B. In operation S39, the control part 33 compares the variation of the food volume calculated in the operation S37 to a preset reference variation. In operation S41, the control part 33 determines whether the variation of the food volume reaches the reference variation.

When the variation of the food volume reaches the reference variation in the operation S41, the control part 33 determines that the cooking of the food in the cooking chamber 11 is finished to stop the operation of the heat source 25. If the variation of the food volume does not reach the reference variation in the operation S41, the control part 33 determines that the cooking of the food in the cooking chamber 11 is not finished yet to perform the operation S37 to S41.

Although one or two image sensors are provided in the foregoing embodiments, the preset disclosure is not limited to the number of image sensor. For example, three image sensors may be provided to scan the inside of the cooking chamber in three directions perpendicular to each other.

It should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims.

### INDUSTRIAL APPLICABILITY

As described above, the cooker according to the embodiments and the method for controlling the cooker have effects as follows. The cooked state of the food may be determined through a variation of the image size of the food scanned by the image sensor or a variation of the food volume calculated from the variation of the image size of the food. Thus, the user may more accurately recognize the whole state of the food.

1-16. (canceled)

17. A cooker comprising:
a cooking chamber in which food is cooked;
a heat source providing heat for heating the food in the cooking chamber;
an image sensor scanning the food in the cooking chamber in a preset direction; and
a control part determining a cooked state of the food from a variation of an image size of the food scanned by the image sensor through an operation of the heat source.

18. The cooker according to claim 17, wherein the control part determines that the cooking of the food is finished when the variation of the image size of the food scanned by the image sensor in one direction reaches a preset reference variation.

19. The cooker according to claim 18, wherein the control part controls the heat source to stop an operation of the heat source when the variation of the image size of the food scanned by the image sensor in the one direction reaches the preset reference variation.

20. The cooker according to claim 17, further comprising a display part for displaying the image of the food scanned by the image sensor.

21. A cooker comprising:
a cooking chamber in which food is cooked;
a heat source providing heat for heating the food in the cooking chamber;
a first image sensor for scanning the food in the cooking chamber in a first direction;
a second image sensor for scanning the food in the cooking chamber in a second direction different from the first direction; and
a control part determining a cooked state of the food from a variation of a food volume calculated from the first and second images of the food scanned by the first and second image sensors through an operation of the heat source.

22. The cooker according to claim 21, wherein the first and second direction are perpendicular to each other.

23. The cooker according to claim 21, wherein the first image sensor is disposed on a ceiling of the cooking chamber, and the second image sensor is disposed on one of both side surface and a back surface of the cooking chamber.

24. The cooker according to claim 21, further comprising a display part for displaying at least one of the first and second images of the food scanned by the first and second image sensors.

25. The cooker according to claim 21, wherein the control part determines that the cooking of the food is finished when the variation of the food volume reaches the preset reference variation according to an elapsed time.

26. The cooker according to claim 25, wherein the control part controls the heat source to stop an operation of the heat source when the variation of the food volume reaches the reference variation.

27. A method for controlling a cooker, the method comprising:
scanning food in a cooking chamber in a horizontal direction through an image sensor;
starting an operation of a heat source to cook the food in the cooking chamber; and
determining a cooked state of the food according to a variation of a horizontal image size of the food scanned by the image sensor through a control part.

28. The method according to claim 27, wherein, in the determining of the cooked state, the control part determines that the cooking of the food is finished when the variation of the horizontal image size of the food scanned by the image sensor reaches a preset reference variation according to an elapsed time.

29. The method according to claim 28, further comprising stopping the operation of the heat source when the control part determines that the cooking of the food is finished.

30. The method according to claim 28, further comprising displaying a horizontal image of the food scanned by the image sensor through a display part in the scanning of the image.

31. The method according to claim 27, wherein, in the scanning of the image, first and second image sensors scan the food in the cooking chamber in vertical and horizontal direction, and
in the determining of the cooked state, the control parts determines the cooked state of the food according to a variation of a food volume of the food calculated from vertical and horizontal food images scanned by the first and second image sensors.

32. The method according to claim 31, wherein the control part determines that the cooking of the food is finished when the variation of the food volume reaches the preset reference variation according to an elapsed time.

33. The method according to claim 32, further comprising stopping the operation of the heat source when the control part determines that the cooking of the food is finished.

34. The method according to claim 31, further comprising displaying at least one of horizontal and vertical images of the food scanned by the first and second image sensors through a display part.
